(19) United States
(12) Patent Application Publication
(10) Pub. No.: US 2019/0080175 A1
(43) Pub. Date: Mar. 14, 2019

(54) METHODS AND SYSTEMS TO IDENTIFY AN OBJECT IN CONTENT

(71) Applicant: Comcast Cable Communications, LLC, Philadelphia, PA (US)

(72) Inventors: Federico Buratti, Lone Tree, CO (US); Luis Luzardo, Parker, CO (US); David Gareis, Thornton, CO (US); Jan Neumann, Arlington, VA (US); Michael Holmes, Devon, PA (US); Barry McMillan, Philadelphia, PA (US)

(21) Appl. No.: 15/704,933

(22) Filed: Sep. 14, 2017

(51) Int. Cl. G06K 9/00; G06K 9/20; G06F 3/0484; G06T 7/73; G06T 7/11; G06Q 30/02

(52) U.S. Cl. CPC G06K 9/00711; G06K 9/2081; G06F 3/04842; G06T 2207/10016; G06T 7/11; G06Q 30/0251; G06T 2207/20132; G06T 7/74

(57) ABSTRACT

Methods and systems for identifying an object in content and determining information associated with the object are provided. A device can be used to select a region comprising an object of interest in content (e.g., video, streaming content). The object of interest can be an object (e.g., an actor, a landmark, text, etc.) a user observes during consumption of the content. The selected region can be defined by temporal and coordinate information associated with the content. The information associated with the content can be analyzed to identify the content, extract an image from the content, identify the object of interest and provide additional information.

### BACKGROUND

When watching video content, a user may observe an object that they would like to learn more about. If the user accesses video content that has been pre-tagged with interaction points or tags for the object to be “actionable,” the user may be able to select and interact with the object (e.g., via a remote control) to learn more about the object. It is difficult, however, for a creator/distributor of the video content to predict which objects in the video content will be relevant to the user. Thus, a user is unable to easily learn more about an object in the video content that has not been pre-tagged. These and other shortcomings are addressed by the methods and systems described herein.

### SUMMARY

It is to be understood that both the following general description and the following detailed description are examples and explanatory only and are not restrictive. Provided are methods and systems that, in one aspect, identify an object in content. A control system (e.g., software and a device such as a remote control) can be used to select a region of interest (ROI) containing an object of interest. The object of interest can be in a frame or another portion of presented content. The object of interest can be an object the user observes during consumption of the content. A timestamp can be generated and associated with the frame that is associated with the object of interest. The location of the ROI can be defined by coordinates (e.g., Cartesian coordinates) associated with the frame.

In another aspect, systems and methods are provided that allow for processing information associated with a selected object, and providing information (e.g., descriptive information) related to the object to a user. When the ROI is selected or defined, associated information can be generated and/or stored that comprises the coordinates, the timestamp, and other data (e.g., metadata, content parameters, content settings, etc.). The information can be transmitted, along with an identifier of the content, to a network device (e.g., server, computing device, etc.). The network device can use the identifier to determine the content and the information to determine the object of interest in the content. For example, the timestamp may be used to determine the frame of the content associated with the object of interest and the coordinates can be used to determine a location/orientation of the object of interest in the frame of the content. The location/orientation of the object of interest in the frame can be analyzed to provide an identification of a type of object in the ROI of the frame, such as a shape, a person, a structure, text, and the like. For example, the location/orientation of the object of interest in the frame can be analyzed to determine/identify the object in the frame as a person. The type of object can then be analyzed to determine the object in the frame.

In another aspect, determining the object in the frame can comprise facial recognition, landmark detection, label detection, logo detection, optical character recognition, determining image attributes, combinations thereof, and the like. For example, facial recognition can be used to determine that the person identified in the frame may be further identified as a specific person, such as a specific actor in a movie. After the object of interest is determined, the network device and/or one or more other devices, can analyze the object. Analyzing the object can comprise determining information associated with the object such as real-time statistics, related content, advertisements, combinations thereof, and the like. For example, determining information associated with the actor can comprise determining other movies the actor may have a role in, advertisements for merchandise associated with the actor, real-time statistics associated with the name of the actor as a search term, combinations thereof, and the like. Results from the analysis can be stored and/or transmitted to a device (e.g., the content player, a display device, a smartphone, a laptop, a computing device, etc.).

Additional advantages will be set forth in part in the description which follows or may be learned by practice. The advantages will be realized and attained by means of the elements and combinations particularly pointed out in the appended claims.

### BRIEF DESCRIPTION OF THE DRAWINGS

The accompanying drawings, which are incorporated in and constitute a part of this specification, provide examples and together with the description, serve to explain the principles of the methods and systems:

FIG. 1 is a block diagram of a system in which the present invention may operate;

FIG. 2 is a diagram of a system to identify an object in content;

FIG. 3 is a flowchart of an example method to identify an object in content;

FIG. 4 is a flowchart of an example method to identify an object in content; and

FIG. 5 is a block diagram of an example computing device in which the present methods and systems operate.

### DETAILED DESCRIPTION

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowcharts of methods, systems, apparatuses and computer program products. It will be understood that each block of the block diagrams and flowcharts, and combinations of blocks in the block diagrams and flowcharts, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowcharts support combinations of means for performing the specified functions, combinations of steps for performing the specified functions and program instruction means for performing the specified functions. It will also be understood that each block of the block diagrams and flowcharts, and combinations of blocks in the block diagrams and flowcharts, can be implemented by special purpose hardware-based computer systems that perform the specified functions or steps, or combinations of special purpose hardware and computer instructions.

In various instances, this detailed description may refer to content items (which may also be referred to as “content,” “content data,” “content information,” “content asset,” “multimedia asset data file,” or simply “data” or “information”). In some instances, content items can comprise any information or data that may be licensed to one or more individuals (or other entities, such as business or group). In various embodiments, content may include electronic representations of video, audio, text and/or graphics, which may include but is not limited to electronic representations of videos, movies, or other multimedia, which may include but is not limited to data files adhering to MPEG2, MPEG, MPEG4 UHD, HDR, 4 k, Adobe® Flash® Video (.FLV) format or some other video file format whether such format is presently known or developed in the future. In various embodiments, the content items described herein may include electronic representations of music, spoken words, or other audio, which may include but is not limited to data files adhering to the MPEG-1 Audio Layer 3 (.MP3) format, Adobe®, CableLabs 1.0, 1.1, 3.0, AVC, HEVC, H.264, Nielsen watermarks, V-chip data and Secondary Audio Programs (SAP). Sound Document (.ASND) format or some other format configured to store electronic audio whether such format is presently known or developed in the future. In some cases, content may include data files adhering to the following formats: Portable Document Format (.PDF), Electronic Publication (.EPUB) format created by the International Digital Publishing Forum (IDPF), JPEG (.JPG) format, Portable Network Graphics (.PNG) format, dynamic ad insertion data (.csv), Adobe® Photoshop® (.PSD) format or some other format for electronically storing text, graphics and/or other information whether such format is presently known or developed in the future. In some embodiments, content items may include any combination of the above-described examples.

In various instances, this detailed disclosure may refer to consuming content or to the consumption of content, which may also be referred to as “accessing” content, “providing” content, “viewing” content, “listening” to content, “rendering” content, or “playing” content, among other things. In some cases, the particular term utilized may be dependent on the context in which it is used. For example, consuming video may also be referred to as viewing or playing the video. In another example, consuming audio may also be referred to as listening to or playing the audio.

Note that in various instances this detailed disclosure may refer to a given entity performing some action. It should be understood that this language may in some cases mean that a system (e.g., a computer) owned and/or controlled by the given entity is actually performing the action.

The present disclosure relates to methods and systems for identifying an object in content. The object in the content can be an object of interest in a frame of displayed content. The object of interest can be an object the user observes during consumption of the content. The object in the content does not have to be pre-tagged by a creator/distributor of the content to be “actionable,” such that it may be identified by a user when the content is displayed by a display device. Instead, a user can use a control device (e.g., a remote control, a touchscreen, etc. . . . ) in communication with a content player (e.g., set-top box, etc. . . . ) to pause content (e.g., a video, streaming content, etc. . . . ) and select a region of interest (ROI) containing the object in the content. For example, the user can use one or more controls (e.g., arrow keys, buttons, interfaces, and the like) configured on a remote control to pause the content as it is being consumed by the user. A pause of the content can cause a frame of the content associated with the object of interest to remain displayed on a display device (e.g., television). While the content is paused, the user can use the one or more controls to move a selector, associated with the remote control and displayed on a device displaying the content, to a desired location on the displayed content. For example, the user can operate one or more one or more controls (e.g., arrow keys, buttons, interfaces, and the like) configured on a remote control to place, draw e.g., tracing an outline of an object), create, and the like the selector on the display of the display device. Thus, the selector can be associated with the remote control and displayed on the display device displaying the content. The selector can be any shape (e.g., a square, a circle, a triangle, a polygon, an irregular shape, etc.), border, freeform object (e.g., a trace of an object), or the like that surrounds, encapsulates, designates, borders, and the like the object in the content. For example, the selector can be an adjustable size shape, such as a rectangle, that appears over the content (e.g., the object of interest) as the content is displayed. The frame associated with the object of interest can be associated with a timestamp. For example, a timestamp of 5-milliseconds can be associated with a frame of the content beginning at 5-millisecond duration of the content. The ROI can be defined by coordinates (e.g., Cartesian coordinates) associated with the frame of the content. The location of the ROI in the frame can correspond to coordinates of the frame of the content. A length of the ROI can correspond to x-axis coordinates of the frame, and a height of the ROI can correspond to y-axis coordinates of the frame of the content. For example, the location of the ROI in the frame can be {(x1, y1), (x2, y2), (x3, y3), (x4, y4)}. The coordinates {(x1, y1), (x2, y2), (x3, y3), (x4, y4)} may represent real numbers associated with axes (e.g., x-axis, y-axis) of the frame of the content.

Information comprising the coordinates and the timestamp associated with the content can be extracted from and/or generated based on the content by a content player. The information comprising the coordinates and the timestamp associated with the content can be extracted from and/or generated based on the content by a content player in response to a selection/confirmation of the ROI. The content player can transmit the information comprising the coordinates, the timestamp, and any other information (e.g., metadata, content parameters, content settings, etc.) along with an identifier of the content to a network device (e.g., server, computing device, etc.). The network device can use the identifier to determine/identify the content. For example, the network device can determine/identify the content by either accessing a profile (e.g., a stored user profile comprising content and associated content identifiers), querying a database, determining a content source, communicating with a content source, accessing program/guide information associated with a content asset, combinations thereof, and the like. After identifying the content, the network device can use the timestamp to determine a frame of the content that is associated with the object of interest. Then, the network device can use the coordinates to determine a location/orientation of the object of interest in the frame of the content.

The location/orientation of the object of interest in the frame can be analyzed to provide an identification of a type object in the ROI of the frame, such as a shape, a person, a structure, text, and the like. For example, the type object (e.g., object of interest) in the ROI of the frame can be identified as a person. The type of object can then be analyzed to determine the object of interest in the frame of the content. For example, the network device can further analyze the type of object to determine that the person identified (e.g., the object of interest) is a specific actor. The network device can determine the object of interest in the frame of the content based on, for example, facial recognition, landmark detection, label detection, logo detection, optical character recognition, determining image attributes, combinations thereof, and the like. After the object of interest is determined, the network device and/or one or more other devices can analyze the object. Analyzing the object can comprise determining information associated with the object such as real-time statistics, related content, advertisements, combinations thereof, and the like. For example, determining information associated with the actor can comprise determining other movies the actor may have a role in, advertisements for merchandise associated with the actor, real-time statistics associated with the name of the actor as a search term, combinations thereof, and the like. Results from the analysis can be stored and/or transmitted to a device (e.g., the content player, a display device, a smartphone, a laptop, a computing device, etc.).

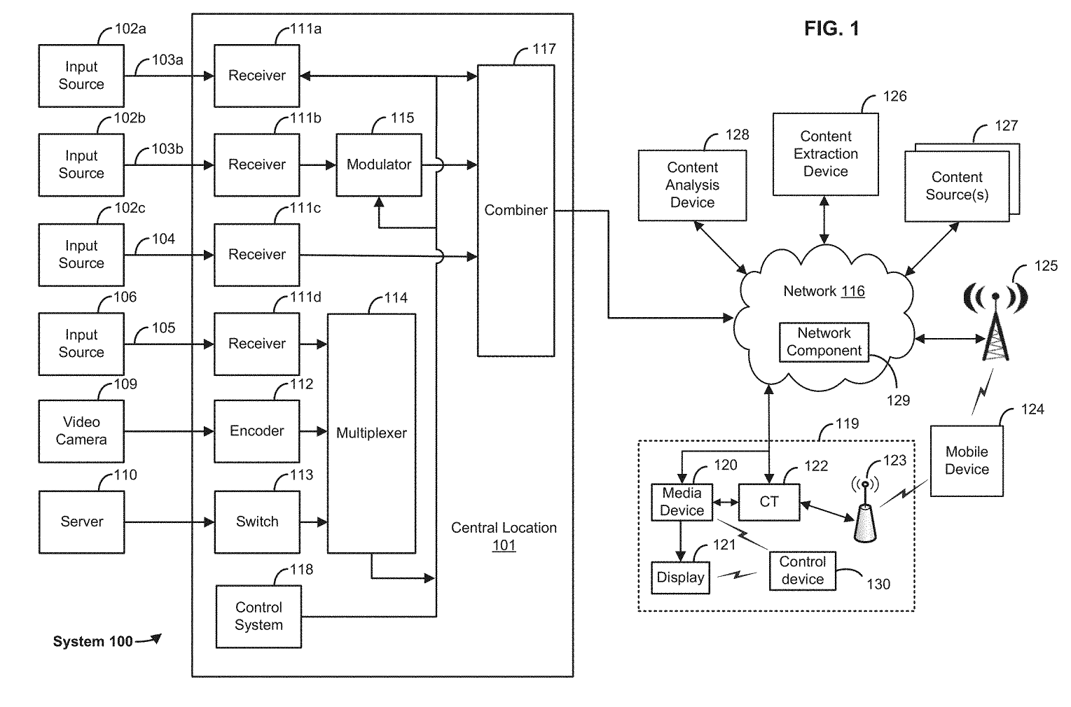

FIG. 1 shows various aspects of an example system in which the present methods and systems can operate. Those skilled in the art will appreciate that present methods may be used in systems that employ both digital and analog equipment. One skilled in the art will appreciate that provided herein is a functional description and that the respective functions can be performed by software, hardware, or a combination of software and hardware.

A system 100 can comprise a central location 101 (e.g., a headend), which can receive content (e.g., data, input programming, and the like) from multiple sources. The central location 101 can combine the content from the various sources and can distribute the content to user (e.g., subscriber) locations (e.g., location 119) via a network 116.

The central location 101 can receive content from a variety of sources 102a, 102b, and 102c. The content can be transmitted from the source to the central location 101 via a variety of transmission paths, including wireless (e.g. satellite paths 103a, 103b) and a terrestrial path 104. The central location 101 can also receive content from a direct teed source 106 via a direct line 105. Other input sources can comprise capture devices such as a video camera 109 or a server 110. The signals provided by the content sources can include a single content item or a multiplex that includes several content items.

The central location 101 can comprise one or a plurality of receivers 111a, 111b, 111e, 111d that are each associated with an input source. For example, MPEG encoders such as an encoder 112 are included for encoding local content or a video camera 109 feed. A switch 113 can provide access to the server 110, which can be a Pay-Per-View server, a data server, an internet router, a network system, a phone system, and the like. Some signals may require additional processing, such as signal multiplexing, prior to being modulated. Such multiplexing can be performed by a multiplexer (mux) 114.

The central location 101 can comprise one or a plurality of modulators 115 for interfacing to a network 116. The modulators 115 can convert the received content into a modulated output signal suitable for transmission over a network 116. The output signals from the modulators 115 can be combined, using equipment such as a combiner 117, for input into the network 116. The network 116 can comprise a content delivery network, a content access network, and/or the like. For example, the network 116 can be configured to provide content from a variety of sources using a variety of network paths, protocols, devices, and/or the like. The content delivery network and/or content access network can be managed (e.g., deployed, serviced) by a content provider, a service provider, and/or the like.

A control system 118 can permit a system operator to control and monitor the functions and performance of the system 100. The control system 118 can interface, monitor, and/or control a variety of functions, including, but not limited to, the channel lineup for the television system, billing for each user, conditional access for content distributed to users, and the like. The control system 118 can provide input to the modulators for setting operating parameters, such as system specific MPEG table packet organization or conditional access information. The control system 118 can be located at the central location 101 or at a remote location.

The network 116 can distribute signals from the central location 101 to user locations, such as a user location 119. The network 116 can comprise an optical fiber network, a coaxial cable network, a hybrid fiber-coaxial network, a wireless network, a satellite system, a direct broadcast system, an Ethernet network, a high-definition multimedia interface network, universal serial bus network, or any combination thereof.

A multitude of users can be connected to the network 116 at one or more of the user locations. At the user location 119, a media device 120 can demodulate and/or decode, if needed, the signals for display on a display device 121, such as on a television set (TV) or a computer monitor. For example, the media device 120 can comprise a demodulator, decoder, frequency tuner, and/or the like. The media device 120 can be directly connected to the network (e.g., for communications via in-band and/or out-of-band signals of a content delivery network) and/or connected to the network 116 via a communication terminal 122 (e.g., for communications via a packet switched network). The media device 120 can comprise a set-top box, a digital streaming device, a gaming device, a media storage device, a digital recording device, a combination thereof, and/or the like. The media device 120 can comprise one or more applications, such as content players/viewers, social media applications, news applications, gaming applications, content stores, electronic program guides, and/or the like. Those skilled in the art will appreciate that the signal can be demodulated and/or decoded in a variety of equipment, including the communication terminal 122, a computer, a TV, a monitor, or satellite dish.

The communication terminal 122 can be located at the user location 119. The communication terminal 122 can be configured to communicate with the network 116. The communications terminal 122 can comprise a modem (e.g., cable modem), a router, a gateway, a switch, a network terminal (e.g., optical network unit), and/or the like. The communications terminal 122 can be configured for communication with the network 116 via a variety of protocols, such as internet protocol, transmission control protocol, file transfer protocol, session initiation protocol, voice over internet protocol, and/or the like. For example, for a cable network, the communication terminal 122 can be configured to provide network access via a variety of communication protocols and standards, such as Data Over Cable Service Interface Specification.

The user location 119 can comprise a first access point 123, such as a wireless access point. The first access point 123 can be configured to provide one or more wireless networks in at least a portion of the user location 119. The first access point 123 can be configured to provide access to the network 116 to devices configured with a compatible wireless radio, such as a mobile device 124, the media device 120, the display device 121, a control device 130 or other computing devices (e.g., laptops, sensor devices, security devices). For example, the first access point 123 can provide a user managed network (e.g., local area network), a service provider managed network (e.g., public network for users of the service provider), and/or the like. It should be noted that in some configurations, some or all of the first access point 123, the communication terminal 122, the media device 120, and the display device 121 can be implemented as a single device.

The user location 119 can comprise the control device 130. The control device 130 can communicate information to a device such as the media device 120, and the display device 121, for example. The control device 130 can be configured for wireless communication with devices (e.g., media device 120, display device 121). The control device 130 can communicate information to the devices (e.g., media device 120, display device 121) via a short-range communication technique (e.g., infrared, BLUETOOTH, ZigBee, RF4CE). Additionally, the control device 130 can communicate information to the devices (e.g., media device 120, display device 121) via any suitable wireless technique/protocol, for example Wi-Fi (IEEE 802.11), cellular, satellite, or any other suitable wireless standard. The information communicated to the media device 120 and/or the display device 121 by the control device 130 can be associated with content shown on the display device 121. For example, the information associated with the content can comprise information associated with an object in a region of interest (ROI) associated with the content. The object in the content can be an object of interest to the user, such as an object the user observes during consumption (e.g., access, play, view, etc.) of the content via the devices (e.g., the media device 120, the display device 121). For example, the user can observe an actor (e.g., object) in content, such as a movie for example, while watching the content on a television display device 121). The region of interest (ROI) can be a region associated with content (e.g., a frame of the content) selected by the user via the control device (e.g., remote control, control device 130). For example, the ROI can be an area of the content depicted on the television and selected by, the user via a remote control in communication with the television. Alternatively, the ROI can be an area of the content depicted on a touchscreen display associated with a television and selected by the user via a touchscreen interface. For example, a user can use a finger, stylus, or the like to draw (e.g., tracing an outline of an object, touching boundary points of an object, etc.), create, identify, or the like a boundary associated with the ROI. Additionally, the ROI can be selected by the user via any other device, such as the media device 120, for example.

The object in the region of interest (ROI) can be selected by a user via the control device 130. For example, the control device 130 can transmit a signal to the devices (e.g., media device 120, display device 121) that causes a selector to appear on the display device 121 during a display of content (e.g., video). The control device 130 can be configured to accept inputs from a user via one or more controls (e.g., arrow keys, buttons, interfaces, and the like). The one or more controls can be associated with function/control of the control device 130. The user can use the one or more controls to pause content being consumed by the user, accessed (e.g., played) by the media device 120, and/or displayed by the display device 121. Temporal information can be associated with the content. When the content being consumed by the user is paused, temporal information (e.g., a timestamp, a time offset, a time window, a start time, an end time, etc.) corresponding to a paused frame of the content can be determined and/or stored by the devices (e.g., media device 120, display device 121). For example, temporal information comprising a time offset of 5-milliseconds can be associated with a frame of the content beginning at 5-millisecond duration of the content. As a further example, temporal information comprising a start time of 5 seconds and an end time of 5.1 seconds can be associated with a frame of the content beginning at a 5-second duration and ending at a 5.1-second duration of the content.

While the content is paused, the user can use one or more controls (e.g., arrow keys, buttons, interfaces, and the like) configured on the control device 130 to move a selector, associated with the control device 130 and displayed on the display device 121, to the desired location on the displayed content. The selector can be any adjustable size shape, such as a rectangle, square, triangle, circle, polygon, irregular shape, and the like, that appears over the content as the content is displayed. The ROI on the displayed content corresponding to the object of interest can be defined by coordinates (e.g., Cartesian coordinates, etc.) associated with a frame of the content. For example, a center of the frame can correspond to an origin associated with a coordinate system (e.g., Cartesian coordinate system). A position of the ROI can correspond to a location within the coordinate system offset from the origin. For example, a length of the adjustable size shape encompassing the ROI can correspond to an x-axis coordinates offset from the origin of the coordinate system associated with the frame, and a height of the adjustable size shape can correspond to a y-axis coordinates offset from the origin of the coordinate system associated with the frame. The coordinates associated with the ROI on the displayed content corresponding to the object of interest can be extracted and/or stored by a device at and/or associated with the user location 119 such as the media device 120, for example. Additionally, the coordinates associated with the ROI on the displayed content corresponding to the object of interest can be stored by other devices (e.g., display device 121, the mobile device 124, and control device 130).

The user location 119 may not be fixed. By way of example, a user can receive content from the network 116 on the mobile device 124. The mobile device 124 can comprise a laptop computer, a tablet device, a computer station, a personal data assistant (PDA), a smart device (e.g., smart phone, smart apparel, smart watch, smart glasses), GPS, a vehicle entertainment system, a portable media player, a combination thereof, and/or the like. The mobile device 124 can communicate with a variety of access points (e.g., at different times and locations or simultaneously if within range of multiple access points). For example, the mobile device 124 can communicate with a second access point 125. The second access point 125 can be a cell tower, a wireless hotspot, another mobile device, and/or other remote access point. The second access point 125 can be within range of the user location 119 or remote from the user location 119. For example, the second access point 125 can be located along a travel route, within a business or residence, or other useful locations (e.g., travel stop, city center, park). The mobile device 124 can communicate with devices such as the media device 120, and a content extraction device 126, for example.

The mobile device 124 can comprise a display for displaying the content. A user can use the mobile device 124 to select an object in a region of interest (ROI) associated with the content. The object in the content can be an object of interest to the user, such as an object the user observes during consumption (e.g., access, play, view, etc.) of the content via the mobile device 124. For example, the user can observe an actor object) in content, such as a movie for example, while watching the content on the mobile device 124. The region of interest (ROI) can be a region associated with content (e.g., a frame of the content) selected by the user via the mobile device 124. For example, the ROI can be an area of the content depicted on a display associated with the mobile device 124 and selected by the user via one or more controls (e.g., arrow keys, buttons, interfaces, and the like) associated with function/control of the mobile device 124. Alternatively, the mobile device 124 can comprise a touchscreen display and the R N can be an area of the content depicted on the touchscreen display of the mobile device 124 and selected by the user via a selector presented on the touchscreen display. For example, a user can use a finger, stylus, or the like to draw/create (e.g., tracing an outline of an object, touching boundary points of an object, etc.) a selector that identifies and/or bounds an object of interest associated with the ROI. After the selector identifies and/or bounds the object of interest associated with the ROI, the mobile device 124 can transmit information associated with the object of interest and/or the ROI to one or more other devices (e.g., the media device 120, content extraction device 126, etc.) for analysis.

The system 100 can comprise one or more content source(s) 127. The content source(s) 127 can be configured to provide content (e.g., video, audio, games, applications, data) to the user. The content source(s) 127 can be configured to provide streaming media, such as on-demand content (e.g., video on-demand), content recordings, and/or the like. For example, the content source(s) 127 can be managed by third party content providers, service providers, online content providers, over-the-top content providers, and/or the like. The content can be provided via a subscription, by individual item purchase or rental, and/or the like. The content source(s) 127 can be configured to provide the content via a packet switched network path, such as via an internet protocol (IP) based connection. The content can be accessed by users via applications, such as mobile applications, television applications, set-top box applications, gaming device applications, and/or the like. An example application can be a custom application (e.g., by content provider, for a specific device), a general content browser (e.g., web browser), an electronic program guide, and/or the like.

The system 100 can comprise a content extraction device 126. The content extraction device 126 can be a computing device, such as a server. The content extraction device 126 can identify content (e.g., a video, a content asset, a content stream, a content item, etc. such as content provided by the content source(s) 127, and extract a content item (e.g., an object in the content, an image, etc.) from the content. The content extraction device 126 can extract an object in the content (e.g., an image, a face, a landmark, text, etc.) from the content by utilizing one or more image extraction techniques such as content recognition, image filtering, edge detection, image space transformation, image entropy and feature detection, and the like, for example. Additionally, the content extraction device 126 can extract the object in the content by submitting the content to an external content recognition tool (e.g., Photoshop®, etc.). The content extraction device 126 can identify content and extract an object (e.g., image) in the content from the content based on information associated with the content, such as an identifier associated with the content (e.g., content identifier, content ID, etc.), temporal information associated with the content (e.g., a timestamp, a time offset, a time window, a start time, an end time, etc.), coordinates (e.g., Cartesian coordinates, etc.) associated with a frame of the content, any other information (e.g., metadata, content parameters, content settings, etc.), combinations thereof, and the like. The information associated with the content can be received from one or more sources, such as the media device 120, the display device 121, and/or the mobile device 124, for example.

The content extraction device 126 can use the information associated with the content to identify content based on a content identifier such as a token, a character, a string, and the like, for differentiating a content item from another content item. The content extraction device 126 can reference the content based on the content identifier by various steps or actions such as, accessing a profile, querying a database, determining a content source content source(s) 127), communicating with a content source (e.g., content source(s) 127), accessing program/guide information associated with a content asset, combinations thereof, and the like, for example.

The content extraction device 126 can use the information associated with the content to extract an object in the content identified by the content identifier. The object in the content can be based on the region of interest (ROI) associated with the frame.

The content extraction device 126 can use temporal information e.g., a timestamp, a time offset, a time window, a start time, an end time, etc.) received with the information associated with the content to determine a frame of the identified content associated with the ROI. For example, temporal information comprising a time offset of 5-milliseconds can be associated with a frame of the content beginning at 5-millisecond duration of the content. As a further example, temporal information comprising a start time of 5 seconds and an end time of 5.1 seconds can be associated with a frame of the content beginning at a 5-second duration and ending at a 5.1-second duration of the content.

The content extraction device 126 can use coordinates (e.g., Cartesian coordinates, Homogeneous coordinates, etc.) associated with the frame of the content to identify a location of the object of interest to the user in the frame of the content. For example, the location of the object of interest to the user in the frame of the content can be defined by coordinates of a rectangle shape used to define the ROI such as {(x1, y1), (x2, y2), (x3, y3), (x4, y4)}. The coordinates {(x1, y1), (x2, y2), (x3, y3), (x4, y4)} may represent real numbers associated with axes (e.g., x-axis, y-axis) of the associated frame of the content. For example, a length of the rectangle shape can correspond to the x-axis coordinates of the content frame, and a height of the rectangle shape can correspond to the y-axis coordinates of the content frame.

The content extraction device 126 can extract the object of interest from a content frame by utilizing one or more image extraction techniques such as content recognition, image filtering, edge detection, image space transformation, image entropy and feature detection, and the like, for example. Additionally, the content extraction device 126 can extract the object of interest from a content frame by submitting the content to an external content recognition tool (e.g., Photoshop®, etc. . . . ).

The content extraction device 126 can provide the extracted object of interest as an image (e.g., an image file, image data, image information, etc.) to a device (e.g., content analysis device 128) for analysis. Additionally, the content extraction device 126 can store the image in a database as a reference.

The content analysis device 128 can be a computing device, such as a server. The content extraction device 126 and the content analysis device 128 can be part of one device, or separate devices. The content analysis device 128 can analyze content, such as an image provided by the content extraction device 126 to determine the object of interest. For example, content analysis device 128 can determine if the extracted image comprises, as objects of interest, a face, a landmark, a label, and/or text, for example. The content analysis device 128 can determine and/or provide an identification of a type object in the image, such as a shape, a person, a structure, text, and the like. For example, the content analysis device 128 can determine the type object in the image to be a person. The content analysis device 128 can further analyze the type of object in the image. For example, the content analysis device 128 can further analyze the type of object to determine that the person identified (e.g., the object of interest) in the image is a specific character/actor (e.g., Samurai Jack, Matt Damon, etc.). The content analysis device 128 can determine the object of interest based on facial recognition, landmark detection, label detection, logo detection, optical character recognition, determining image attributes, combinations thereof, and the like. Additionally, the content analysis device 128 can analyze the image and determine ancillary information associated with the object(s) of interest (e.g., a face, a landmark, a label, a logo, text, etc.). For example, the content analysis device 128 can analyze the image and determine ancillary information associated with the specific actor (e.g., Samurai Jack, Matt Damon, etc.). For example, determining ancillary information associated with the specific actor can comprise determining other movies the actor may have a role in, advertisements for merchandise associated with the actor, real-time statistics associated with the name of the actor as a search term, combinations thereof, and the like. Additionally, the content analysis device 128 can determine the object of interest by providing the image extracted from the identified content to an image search tool (e.g., Google® Image Search) and/or a search engine/cognitive service (e.g., Amazon Rekognition, Clarifai, Microsoft Azure Cognitive Services, Google Image Intelligence, Bing®, IBM Watson®, etc.) for analysis. The image search tool and/or cognitive service can analyze the image extracted from the identified content by applying computer vision and image analysis algorithms to detect the presence of specific persons, objects, brands, logos, text, etc. within the ROI. The content analysis device 128 can provide results of the extracted image analysis, such as the determined object of interest and/or ancillary information associated with the determined object of interest, to a device such as media device 120, for example. The content analysis device 128 can provide results of the extracted image analysis, such as the determined object of interest and/or ancillary information associated with the determined object of interest, to other devices, such as the display device 121, and the mobile device 124, for example. The content analysis device 128 can provide results of the extracted image analysis devices via an email, an application notification, a SMS message, an internet interface (e.g., webpage), code, a script, combinations thereof, and the like.

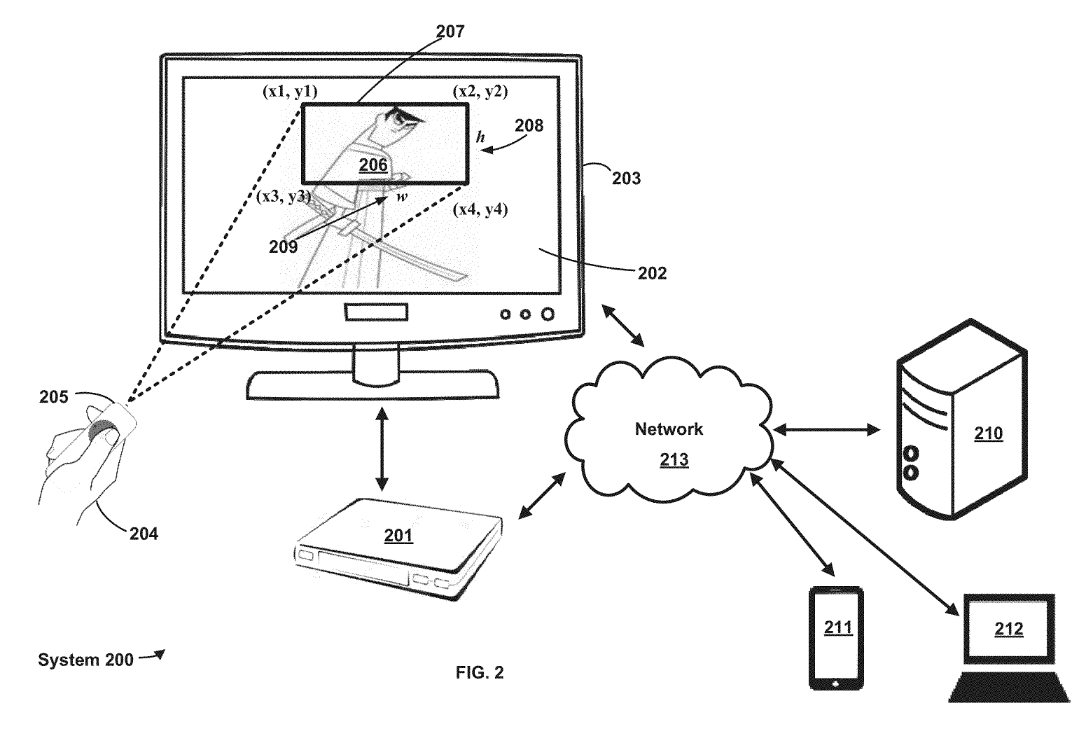

FIG. 2 details an example system in which the present methods and systems can operate. A system 200 can comprise a content player 201 (e.g., media device 120, set-top box, etc.). The content player 201 can access (e.g., play, consume, etc.) content 202 (e.g., video, internet protocol video, streaming video, etc. . . . ) provided by one or more content sources (e.g., content source(s) 127) via a network 213. The content player 201 can cause the content 202 to be displayed on a display device 203 (e.g., television, smart TV, the display device 121). The display device 203 can access (e.g., play, consume, etc.) the content 202 and display the content 202.

A user 204 watching content 202 on the display device 203 can use a remote control 205 (e.g., the control device 130) in communication with the content player 201 and/or the display device 203 to pause the content 202 displayed on the display device 203. The paused content 202 can be associated with temporal information (e.g., a timestamp). For example, temporal information comprising a time offset of 5-milliseconds can be associated with a frame of the content 202 beginning at 5-millisecond duration of the content 202. When the content 202 is paused, the user 204 can interact/communicate with the content player 201 and/or the display device 203 to select an object of interest 206 in the content 202. For example, when the content 202 is paused, the user 204 can interact/communicate with the content player 201 and/or the display device 203 via the remote control 205 to select an object of interest 206 in the content 202. The user 204 can use the remote control 205 to cause a selector 207 to appear over the content 202 displayed on the display device 203. The selector 207 may originally be placed at a center (e.g., origin) of the display of the display device 203.

The user 204 can use one or more controls (e.g., arrow keys, buttons, interfaces, and the like) configured on the remote control 205 to move the selector 207 to a region of interest (ROI) on the displayed contented 202. The ROI can correspond to a location on the content 202 where the user 204 observes the object of interest 206 in the content 202. Each of the one or more controls (e.g., arrow keys, buttons, interfaces, and the like) can is translate into coordinates associated with the selector 207 in each direction. For example, an arrow key associated with transmitting a signal (e.g., code) to the content player 201 and/or display device 203 corresponding to either an “UP” or “DOWN” function (or any similar function/control) can cause the selector 207 to move from the center of the display of the display device 203 in a direction along a vertical axis (e.g., y-axis) associated with the content 202. Additionally, an arrow key associated with transmitting a signal (e.g., code) to the content player 201 and/or display device 203 corresponding to either an “RIGHT” or “LEFT” function (or any similar function/control) can cause the selector 207 to move from the center (e.g., origin) of the display of the display device 203 in a direction along a horizontal axis (e.g., x-axis) associated with the content 202. Locations along the axes e.g., x-axis, y-axis can be associated with coordinates such as (x1, y1), for example. As such, a position, size, and shape of the selector 207 can be defined by coordinates. The selector 207 can be defined by coordinates {(x1, y1), (x2, y2), (x3, y3), (x4, y4)}. For example, the coordinates (x2, y2) and (x4, y4) can define a location and height (h) 208 of the selector 207. The coordinates (x3, y3) and (x4, y4) can define a location and width (w) 209 of the selector 207.

The selector 207 can be placed over the ROI corresponding to a location on the content 202 where the user 204 observes the object of interest 206 in the content 202 by pressing the one or more controls (e.g., arrow keys, buttons, interfaces, and the like) to adjust the size and location of the selector 207 along the axes. When the selector 207 is in a desired location, such as the location corresponding to the ROI associated with the object of interest, the user 204 can press one or more controls (e.g., arrow keys, buttons, interfaces, and the like) associated with transmitting a signal (e.g., code) to the content player 201 and/or display device 203 associated with a confirmation function/control, such as “OK”, for example. The press of the one or more controls associated with transmitting the signal (e.g., code) associated with a confirmation function/control can cause the selector 207 to select/confirm the ROI in the content 202 associated with the object of interest 206.

Selecting/confirming the ROI in the content 202 associated with the object of interest 206 can cause the content player 201 and/or display device 203 to extract/record/store information associated with the content 202. The information associated with the content 202 can comprise an identifier associated with the content 202 (e.g., content identifier) and information associated with the ROI. The information associated with the content 202 can comprise the temporal information associated with the paused content 202 and the coordinate information associated with the ROI. The content player 201 and/or display device 203 can transmit, via the network 213, the information associated with the content 202 to a server 210 (e.g., content extraction device 126, content analysis device 128) to extract and analyze an image comprising the object of interest 206 in the content 202. As such, the object of interest 206 can be identified by the server 210 and the identification along with ancillary information associated with the object of interest 206 can be provided to one or more devices (e.g., content player 201, display device 203, smartphone 211, and laptop 212) associated with the user 204. The server 210 can provide the identification along with the ancillary information the one or more devices via various communication channels/techniques such as an email, an application notification, a SMS message, an internet interface webpage), combinations thereof, and the like.

The server 210 can receive the information associated with the content 202 from a device consuming (e.g., accessing, displaying, streaming, etc.) the content 202, such as the content player 201, for example. The server 210 can use the information associated with the content 202 to extract an image comprising the object of interest 206, identify, the object of interest 206, and provide ancillary information associated with the object of interest 206 to one or more devices (e.g., content player 201, display device 203, smartphone 211, and laptop 212) associated with the user 204.

The server 210 can use the information associated with the content 202 to identify the content 202 based on a content identifier. The content identifier can be any identifier, token, character, string, or the like, for differentiating a content item (e.g., video, content asset, content stream, etc.) from another content item. The server 210 can reference the content 202 based on the content identifier by various means, steps, or actions such as, accessing a profile (e.g., a stored user profile comprising content and associated content identifiers), querying a database, determining a content source (e.g., content source(s) 127), communicating with a content source (not shown), accessing program/guide information associated with a content asset, combinations thereof, and the like.

The server 210 can use temporal information (e.g., a timestamp, a time offset, a time window, a start time, an end time, etc.) received with the information associated with the content 202 to determine a frame (e.g., the paused frame of the content 202) of the identified content 202 associated with the ROI. For example, temporal information comprising a time offset of 5-milliseconds can be associated with a frame of the content 202 beginning at 5-millisecond duration of the content 202.

The server 210 can use the coordinates that define a location, height (h) 208 and width (w) 209 of the selector 207 determine a location of the object of interest 206 in the frame of the content 202. For example, the location of the object of interest 206 can be defined by the coordinates {(x1, y1), (x2, y2), (x3, y3), (x4, y4)} associated with the selector 207 used to define the ROI.

The server 210 can extract an image comprising the object of interest 206 from the frame of the content 202. Once the image is extracted, the server 210 can analyze the image to determine/identify the object of interest 206. The server 210 can determine/identify the object of interest 206 based on facial recognition, landmark detection, label detection, logo detection, optical character recognition, determining image attributes, combinations thereof, and the like. For example, the server 210 can use facial recognition or a similar technique to identify the character in the object of interest 206 as Samurai Jack. Additionally, the extracted image can be provided to an image search service, search engine, and or cognitive service for further analysis. The image search service, search engine, and or cognitive service can provide ancillary information associated with the content 202. For example, the image search service, search engine, and or cognitive service can provide promotional links, advertisements, content recommendations, real-time statistical information, combinations thereof, and the like associated with the object of interest 206 to devices, such as devices associated with the user 204 (e.g., content player 201, smartphone 211, laptop 212, etc.). For example, ancillary information associated with the content 202 can include advertisements relating to the character Samurai Jack, recommendations for movies/shows that include Samurai jack, real-time statistics associated with the term “Samurai Jack” as a search term, combinations thereof, and the like.

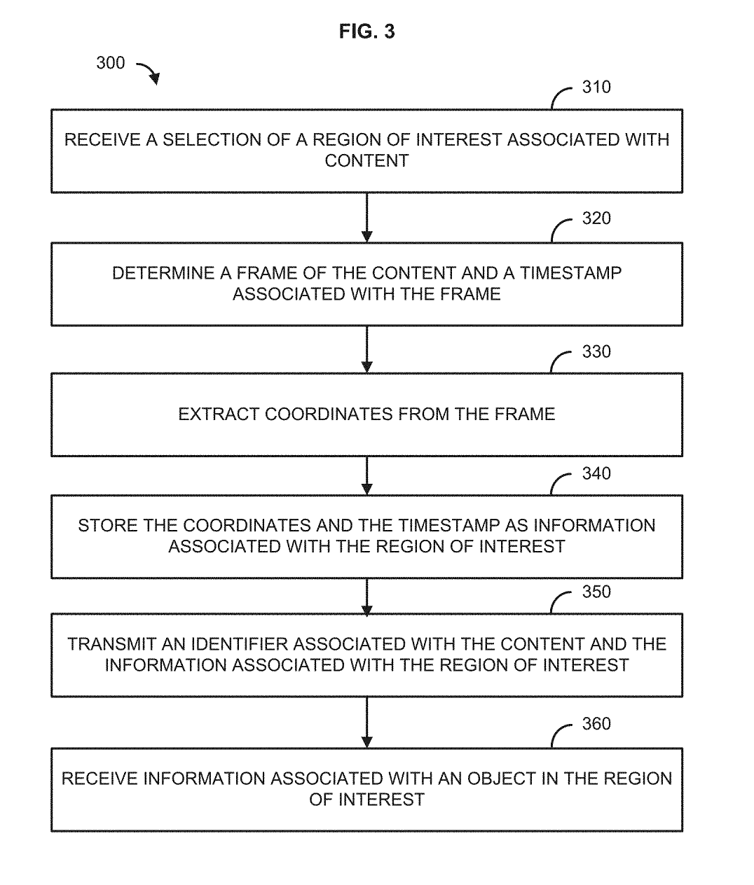

FIG. 3 is a flowchart of an example method to identify an object in content. At step 310, a content player (e.g., media device 120, content player 201, a computing device, etc.) can receive a selection of a region of interest (ROI) associated with content (e.g., video, streaming content, content item, content asset, etc.). The ROI can be associated with an object in the content. The object in the content can be an object of interest to a user, such as an object the user observes during consumption of the content. The ROI can be a region associated with the content (e.g., a frame of the content) selected by the user via a remote control (e.g., control device 130, remote control 205, etc.) or any similar method. For example, a selection of the ROI can comprise activating one or more controls. The one or more controls can cause a selector to appear on a display associated with the content player as the content is displayed. The one or more controls can be used to cause the selector to encompass an area associated the object during the display of the content. For example, the one or more controls can be used to adjust a position of the selector determined from an origin associated with a coordinate system. The one or more controls can be used to adjust a size of the selector, such as where the size is associated with a length of the selector based on x-axis coordinates of the coordinate system and a height of the selector based on y-axis coordinates of the coordinate system, for example. Once the selector encompasses the desired area, the one or more controls can be used to confirm the area.

The content player can receive the selection of the ROI from the remote control. Additionally, the ROI can be a region associated with the content (e.g., a frame of the content) selected by the user via one or more controls (e.g., arrow keys, buttons, interfaces, and the like) associated with the content player. The content player can receive the selection of the ROI via the one or more controls associated with the content player.

At step 320, the content player can determine, based on the selection, a frame of the content and a timestamp associated with the frame. For example, the ROI can be defined by a timestamp associated with a frame of the content, and coordinates (e.g., Cartesian coordinates, Homogenous coordinates, etc.) associated with the frame of the content. The content player can determine a frame of the content based on the timestamp. The timestamp can correspond to a time/period during a runtime/duration of the content when the content was paused for the selection of the ROI. For example, a timestamp of 5-milliseconds can be associated with a frame of the content beginning at 5-millisecond duration of the content. The content player can determine a location of the ROI in the frame of the content based on the coordinates associated with the frame of the content. For example, a center of the frame can correspond to an origin associated with a coordinate system.

At step 330, the content player can extract coordinates from the frame and/or determine that the location of the ROI corresponds to coordinates of the frame of the content. The coordinates can correspond to a position of the ROI offset from the origin. A length of the ROI can correspond to x-axis coordinates of the frame of the content, and a height of the ROI can correspond to y-axis coordinates of the frame of the content. For example, the location of the ROI in the frame of the content can be {(x1, y1), (x2, y2), (x3, y3), (x4, y4)}. The coordinates {(x1, y1), (x2, y2), (x3, y3), (x4, y4)} may represent real numbers associated with axes (e.g., x-axis, y-axis) of the frame of the content.

At step 340, the content player can compile the coordinates and the timestamp along with any other information (e.g., metadata, content parameters, content settings, etc.) as information associated with the ROI. For example, the content player can store the coordinates, the timestamp, and any other information (e.g., metadata, content parameters, content settings, etc.), as information associated with the ROI. The content player can store the information associated with the ROI in a temporary cache or in a database.

At step 350, the content player can transmit an identifier associated with the content and the information associated with the ROI. The content player can transmit the identifier and the information associated with the ROI to a network device (e.g., content extraction device 126, server 210). The network device can identify the content based on a content identifier. The content identifier can be any identifier, token, character, string, or the like, for differentiating a content item (e.g., video, content asset, content stream, etc.) from another content item.

The network device can reference the content based on the content identifier by either accessing a profile (e.g., a stored user profile comprising content and associated content identifiers), querying a database, determining a content source (e.g., content source(s) 127), communicating with a content source, accessing program/guide information associated with a content asset, combinations thereof, and the like. The network device can use the timestamp received with the information associated with the ROI to determine a frame of the identified content associated with the ROI. For example, a timestamp of 5-milliseconds can be associated with a frame of the content beginning at 5-millisecond duration of the content.

The network device can use the coordinates that define the location of the ROI to determine a location of the object of interest in the ROI associated with frame of the content. For example, the location of the object of interest can be defined by the coordinates {(x1, y1), (x2, y2), (x3, y3), (x4, y4)} associated with the ROI.

The network device can extract an image comprising an object of interest from the frame of the identified content by utilizing one or more image extraction techniques such as content recognition, image filtering, edge detection, image space transformation, image entropy and feature detection, and the like, for example. Additionally, the network device can extract the image comprising the object of interest from the frame of the identified content by submitting the frame of the identified content to an external content recognition tool (e.g., Photoshop®, etc.). Once the image is extracted, the network device can analyze the image to determine/identify the object of interest. The network device can determine/identify the object of interest based on facial recognition, landmark detection, label detection, logo detection, optical character recognition, determining image attributes, combinations thereof, and the like. For example, the network device can use facial recognition or a similar technique to identify an actor displayed in the content that is of interest to the user. Additionally, the extracted image can be provided to an image search tool (e.g., Google® Image Search) and/or a search engine/cognitive service (e.g., Bing®, IBM Watson®, etc.) for analysis. The image search service, search engine, and or cognitive service can provide ancillary information associated with the object of interest and/or the content. For example, the image search service, search engine, and or cognitive service can provide promotional links, advertisements, content recommendations, real-time statistical information, combinations thereof, and the like associated with the object of interest that may be provided to the content player. F©r example, ancillary information associated with the object of interest can include advertisements relating to the object of interest, recommendations for content associated with and/or related to the object of interest, real-time statistics associated with search terms associated with the object of interest, combinations thereof, and the like.

At step 360, the content player can receive information associated with the object of interest in the ROI from the network device. The content player can receive the information associated with the object of interest in response to transmitting the identifier and the information associated with the region of interest. The information associated with the object of interest can comprise identification information, descriptive information, or a combination thereof. For example, the information associated with the object of interest can identify for the user what the object in the ROI is (e.g., a person, a place, a thing). The information associated with the object of interest can provide a description of what the object in the ROI is (e.g., a particular actor, an event, an attribute, information relative to identify, etc.). Additionally, the information associated with the object of interest can comprise advertisement information, content recommendation information, or a combination thereof related to the object. For example, the information associated with the object can include an advertisement for a new movie starring an actor identified as the object, or a recommendation for other shows or movies starring the actor.

In response to receiving the information associated with the object of interest in the ROI from the network device, the content player can cause the information associated with the object of interest to display on a display device (e.g., display device 121, display device 203) associated with the content player. Additionally, the network device can provide the information associated with the object of interest in the ROI to other devices (e.g., mobile device 124, smartphone 211, and laptop 212). The network device can provide the information associated with the object of interest in the ROI to other devices via various communication channels/techniques such as an email, an application notification, a SMS message, an internet interface (e.g., webpage), combinations thereof, and the like.

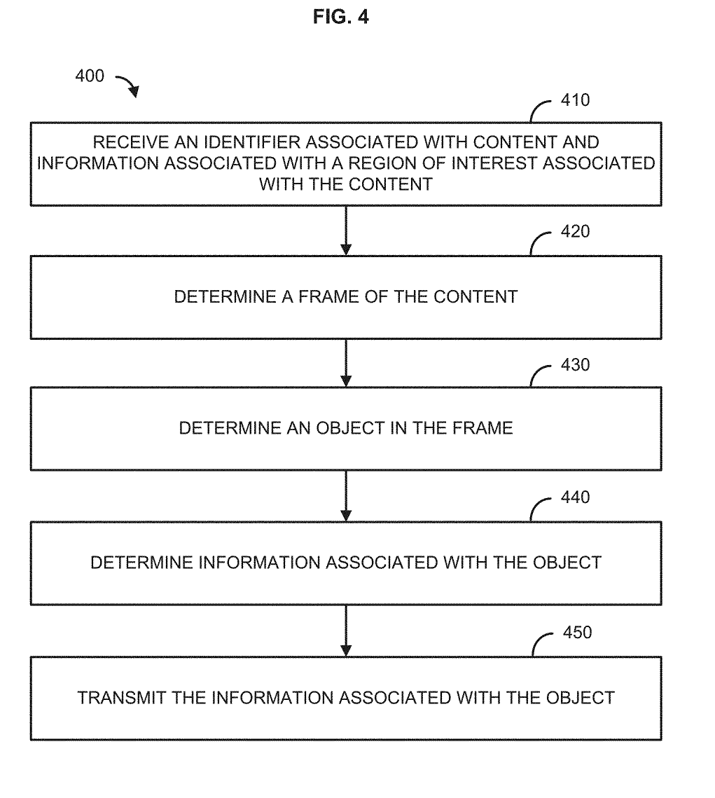

FIG. 4 is a flowchart of an example method to identify an object in content. At step 410, a network device (e.g., content extraction device 126, content analysis device 128, and server 210) can receive an identifier associated with content (e.g., video, content asset, content stream, etc.) and information associated with a region of interest (ROI) associated with the content. The identifier (e.g., content identifier) can be any identifier, token, character, string, or the like, for differentiating one content item (e.g., video, content asset, content stream, etc.) from another content item. The ROI can be associated with an object in the content. The object in the content can be an object of interest to a user, such as an object the user observes during consumption of the content. The ROI can be a region associated with the content (e.g., a frame of the content) selected by the user via a remote control (e.g., control device 130, remote control 205, etc.) or any similar method. For example, a selection of the ROI can comprise activating one or more controls. The one or more controls can cause a selector to appear on a display associated with a content player configured to display the content. The one or more controls can be used to cause the selector to encompass an area associated the object during display of the content. For example, the one or more controls can be used to adjust a position of the selector determined from an origin associated with a coordinate system. The one or more controls can be used to adjust a size of the selector, such as where the size is associated with a length of the selector based on x-axis coordinates of the coordinate system and a height of the selector based on y-axis coordinates of the coordinate system, for example. Once the selector encompasses the desired area, the one or more controls can be used to confirm the area. The information associated with the ROI can comprise coordinates and a timestamp.

The ROI can be defined by a timestamp associated with a frame of the content, and coordinates (e.g., Cartesian coordinates, Homogenous coordinates, etc.) associated with the frame of the content. The timestamp can correspond to a time/period during a runtime/duration of the content when the content was paused for the selection of the ROI. For example, a timestamp of 5-milliseconds can be associated with a frame of the content beginning at 5-millisecond duration of the content. A location of the ROI in the frame of the content can be defined by coordinates associated with the frame of the content. For example, a center of the frame can correspond to an origin associated with a coordinate system. The coordinates can correspond to a position of the ROI offset from the origin. A length of the ROI can correspond to x-axis coordinates of the frame of the content, and a height of the ROI can correspond to y-axis coordinates of the frame of the content. For example, the location of the ROI in the frame of the content can be {(x1, y1), (x2, y2), (x3, y3), (x4, y4)}. The coordinates {(x1, y1), (x2, y2), (x3, y3), (x4, y4)} may represent real numbers associated with axes (e.g., x-axis, y-axis) of the frame of the content.

At step 420, the network device can determine a frame of the content. The network device can determine the frame of the content based on the identifier and the timestamp received with the information associated with the ROI. The network device can determine the content based on the content identifier by either accessing a profile (e.g., a stored user profile comprising content and associated content identifiers), querying a database, determining a content source (e.g., content source(s) 127), communicating with a content source, accessing program/guide information associated with a content asset, combinations thereof, and the like. After determining the content based on the identifier, the network device can use the timestamp received with the information associated with the ROI to determine a frame of the identified content. For example, a timestamp of 5-milliseconds can be associated with a frame of the content beginning at 5-millisecond duration of the content. After the timestamp is used to determine the frame, the network device can determine an object in the frame.

At step 430 the network device can determine an object in the frame. The network device can determine the object in the frame based on the coordinates. The object in the frame can be an object of interest in the ROI associated with frame of the content. The object in the frame can be an object of interest to a user, such as an object the user observes during consumption of the content. The network device can use the coordinates that define the location of the ROI to determine a location of an object in the frame. For example, the location of the object in the frame can be defined by the coordinates {(x1, y1), (x2, y2), (x3, y3), (x4, y4)} associated with the {(x1, y1), (x2, y2), (x3, y3), (x4, y4)} associated with the ROI.

The network device, based on the location of the object in the frame, can extract an image comprising the object in the frame. After the image is extracted, the network device can analyze the image to determine/identify the object in the frame. Alternatively, the network device can extract an image of the frame from the content, and determine the location of the object in the frame based on coordinates {(x1, y1), (x2, y2), (x3, y3), (x4, y4)} associated with the ROI. The extracted image can be cropped to remove area of the image surrounding the location of the object. The network device can determine/identify, the object in the frame and/or cropped image based on image processing that includes facial recognition, landmark detection, label detection, logo detection, optical character recognition, determining image attributes, combinations thereof, and the like. For example, the network device can use facial recognition or a similar technique to identify an actor displayed in the frame of the content that is of interest to the user. Additionally, the network device can determine ancillary information associated with the object in the frame.

At step 440 the network device can determine information associated with the object in the frame. The network device can provide the extracted image associated with the object in the frame and/or descriptive text associated with the object in the frame to an image search tool (e.g., Google® Image Search) and/or a search engine/cognitive service (e.g., Bing®, IBM Watson®, etc.) for analysis. The image search service, search engine, and or cognitive service can provide ancillary information associated with the object in the frame and/or the content. For example, the image search service, search engine, and or cognitive service can provide promotional links, advertisements, content recommendations, real-time statistical information, combinations thereof, and the like associated with the object in the frame. The network device can package, bundle and/or compile the ancillary information associated with the object in the frame and provide it to a device, such as the media device 120, the content player 201, the mobile device 124, and a computing device, for example. Ancillary information associated with the object in the frame can include advertisements relating to the object in the frame, recommendations for content associated with and/or related to the object in the frame, real-time statistics associated with search terms associated with the object in the frame, combinations thereof, and the like. The network device can store the information associated with the object in the frame, such as in a database or a profile associated with the user.

At step 450, the network device can transmit the information associated with the object in the frame. The network device can transmit/provide the information associated with the object in the frame to one or more devices (e.g., mobile device 124, smartphone 211, and laptop 212). The network device can provide the information associated with the object of interest in the ROI to other devices via various communication channels/techniques such as an email, an application notification, a SMS message, an internet interface (e.g., webpage), combinations thereof, and the like.

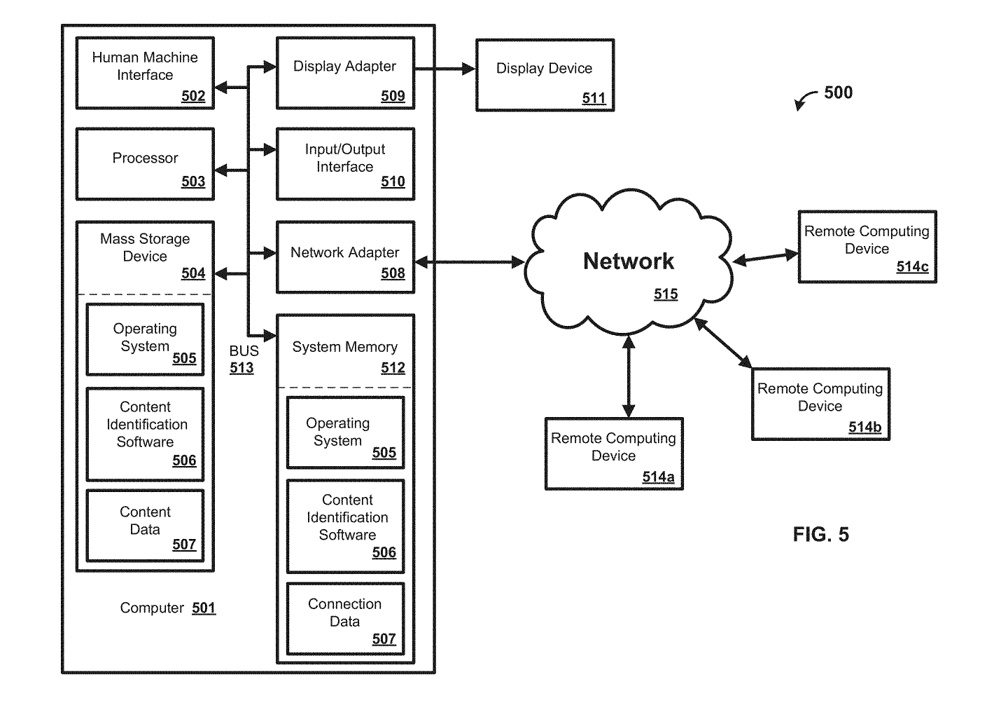

The methods and systems can be implemented on a computer 501 in FIG. 5 and described below. By way of example, the media device 120, the display device 121, the mobile device 124, the content extraction device 126, the content analysis device 128, the control device 130, the content player 201, the display device 203, the remote control 205, the server 210, the smartphone 211, and the laptop 212 can be a computer in FIG. 5. Similarly, the methods and systems disclosed can utilize one or more computers to perform one or more functions in one or more locations. FIG. 5 is a block diagram of an example operating environment for performing the disclosed methods. This operating environment is only an example of an operating environment and is not intended to suggest any limitation as to the scope of use or functionality of operating environment architecture. Neither should the operating environment be interpreted as having any dependency or requirement relating to any one or combination of components in the example operating environment.

The present methods and systems can be operational with numerous other general purpose or special purpose computing system environments or configurations. Examples of well-known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

Further, one skilled in the art will appreciate that the systems and methods disclosed herein can be implemented via a general-purpose computing device in the form of a computer 501. The components of the computer 501 can comprise, but are not limited to, one or more processors 503, a system memory 512, and a system bus 513 that couples various system components including the one or more processors 503 to the system memory 512. The system can utilize parallel computing.

The system bus 513 represents one or more of several possible types of bus structures, including a memory bus or memory controller, a peripheral bus, an accelerated graphics port, or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 513, and all buses specified in this description can also be implemented over a wired or wireless network connection and each of the subsystems, including the one or more processors 503, a mass storage device 504, an operating system 505, content identification software 506, content data 507, a network adapter 508, the system memory 512, an Input/Output Interface 510, a display adapter 509, a display device 511, and a human machine interface 502, can be contained within one or more remote computing devices 514a,b,c at physically separate locations, connected through buses of this form, in effect implementing a fully distributed system.

The computer 501 typically comprises a variety of computer readable media. Readable media can be any available media that is accessible by the computer 501 and comprises, for example and not meant to be limiting, both volatile and non-volatile media, removable and non-removable media. The system memory 512 comprises computer readable media in the form of volatile memory, such as random access memory (RAM), and/or non-volatile memory, such as read only memory (ROM). The system memory 512 typically contains data such as the content data 507 and/or program modules such as the operating system 105 and the content identification software 506 that are immediately accessible to and/or are presently operated on by the one or more processors 503.

The computer 501 can also comprise other removable/non-removable, volatile/non-volatile computer storage media. By way of example, FIG. 5 details the mass storage device 504 which can provide non-volatile storage of computer code, computer readable instructions, data structures, program modules, and other data for the computer 501. For example and not meant to be limiting, the mass storage device 504 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 504, including by way of example, the operating system 105 and the content identification software 106. Each of the operating system 105 and the content identification software 106 (or some combination thereof) can comprise elements of the programming and the content identification software 106. The content data 107 can also be stored on the mass storage device 104. The content data 107 can be stored in any of one or more databases known in the art. Examples of such databases comprise, DB2®, Microsoft® Access, Microsoft® SQL Server, Oracle®, MySQL, PostgreSQL, and the like. The databases can be centralized or distributed across multiple systems.

The user can enter commands and information into the computer 501 via an input device (not shown). Examples of such input devices comprise, but are not limited to, a keyboard, pointing device (e.g., a “mouse”), a microphone, a joystick, a scanner, tactile input devices such as gloves, other body coverings, and the like. These and other input devices can be connected to the one or more processors 503 via the human machine interface 502 that is coupled to the system bus 513, but can be connected by other interface and bus structures, such as a parallel port, game port, an IEEE 1394 Port (also known as a Firewire port), a serial port, or a universal serial bus (USB).

The display device 511 can also be connected to the system bus 513 via an interface, such as the display adapter 509. It is contemplated that the computer 501 can have more than one display adapter 509 and the computer 501 can have more than one display device 511. For example, the display device 511 can be a monitor, an LCD (Liquid Crystal Display), or a projector. In addition to the display device 511, other output peripheral devices can comprise components such as speakers (not shown) and a printer (not shown) which can be connected to the computer 501 via the Input/Output Interface 510. Any step and/or result of the methods can be output in any form to an output device. Such output can be any form of visual representation, including, but not limited to, textual, graphical, animation, audio, tactile, and the like. The display device 511 and computer 501 can be part of one device, or separate devices.

The computer 501 can operate in a networked environment using logical connections to one or more remote computing devices 514a,b,c. By way of example, a remote computing device can be a personal computer, portable computer, smartphone, a server, a router, a network computer, a peer device or other common network node, and so on. Logical connections between the computer 501 and a remote computing device 514a,b,c can be made via a network 515, such as a local area network (LAN) and/or a general wide area network (WAN). Such network connections can be through the network adapter 508. The network adapter 508 can be implemented in both wired and wireless environments. Such networking environments are conventional and commonplace in dwellings, offices, enterprise-wide computer networks, intranets, and the Internet.

For purposes of example, application programs and other executable program components such as the operating system 505 are shown herein as discrete blocks, although it is recognized that such programs and components reside at various times in different storage components of the computing device 501, and are executed by the one or more processors 503 of the computer. An implementation of the content identification software 106 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Example computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The following examples are put forth so as to provide those of ordinary skill in the art with a complete disclosure and description of how the compounds, compositions, articles, devices and/or methods claimed herein are made and evaluated, and are intended to be purely example and are not intended to limit the scope of the methods and systems. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

The methods and systems can employ Artificial Intelligence techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

While the methods and systems have been described in connection with preferred embodiments and specific examples, it is not intended that the scope be limited to the particular embodiments set forth, as the embodiments herein are intended in all respects to be example rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as example only, with a true scope and spirit being indicated by the following claims.

What is claimed is:

1. A method comprising,
receiving, by a content player, a selection of a region of interest associated with content;
determining, based on the selection, a frame of the content and a timestamp associated with the frame;
extracting coordinates from the frame, wherein the coordinates correspond to a position of the region of interest in the frame;
storing the coordinates and the timestamp as information associated with the region of interest;
transmitting an identifier associated with the content and the information associated with the region of interest; and
in response to transmitting the identifier and the information associated with the region of interest, receiving information associated with an object in the region of interest.

2. The method of claim 1, wherein the selection of the region of interest comprises:
activating one or more controls that cause a selector to appear on a display associated with the content player as the content is displayed;
causing, via the one or more controls, the selector to encompass an area associated the object during the display of the content; and
confirming, via the one or more controls, the area.

3. The method of claim 3, wherein causing the selector to encompass the area comprises adjusting a position and size of the selector, wherein the position is determined from an origin associated with a coordinate system, and the size is associated with a length of the selector based on x-axis coordinates of the coordinate system and a height of the selector based on y-axis coordinates of the coordinate system.

4. The method of claim 1, wherein the information associated with the object comprises identification information, descriptive information, or a combination thereof.

5. The method of claim 1, wherein the information associated with the object comprises an advertisement associated with the object, a recommendation, or a combination thereof.

6. The method of claim 1, further comprising causing at least a portion of the information associated with the object to display on a display device associated with the content player.

7. A method comprising,
receiving, by a network device, an identifier associated with content and information associated with a region of interest associated with the content, wherein the information associated with the region of interest comprises coordinates and a timestamp;
determining, based on the identifier and the timestamp, a frame of the content;
in response to determining the frame, determining, based on the coordinates, an object in the frame;
in response to determining the object in the frame, determining information associated with the object; and
transmitting the information associated with the object.

8. The method of claim 7, wherein determining the object in the frame comprises:
extracting an image from the frame;
determining, based on the coordinates, a location of the object in the image;
cropping the image to remove area of the image surrounding the location of the object; and
performing image processing on the cropped image.

9. The method of claim 8, wherein the image processing comprises one or more of facial recognition, landmark detection, label detection, logo detection, optical character recognition, determining image attributes, or a combination thereof.

10. The method of claim 7, wherein determining the information associated with the object comprises one or more of providing descriptive text associated with the object to a search engine, providing an image of the object to an image analyzer, or a combination thereof.

11. The method of claim 7, wherein transmitting the information associated with the object comprises transmitting the information to a content player.

12. The method of claim 7, wherein the information associated with the object comprises identification information, descriptive information, or a combination thereof.

13. The method of claim 7, wherein the information associated with the object comprises an advertisement associated with the object, a recommendation, or a combination thereof.

14. The method of claim 7, wherein the region of interest is determined by:
activating one or more controls that cause a selector to appear on a display as the content is displayed;
causing, via the one or more controls, the selector to encompass an area associated an object in the content during the display of the content; and
confirming, via the one or more controls, the area as the region of interest.

15. The method of claim 14, wherein causing the selector to encompass the area comprises adjusting a position and size of the selector, wherein the position is determined from an origin associated with a coordinate system, and the size is associated with a length of the selector based on x-axis coordinates of the coordinate system and a height of the selector based on y-axis coordinates of the coordinate system.

16. A system, comprising:
a control device configured to:
activate one or more controls that cause a selector to appear on a display associated with a content player as the content is displayed;
cause, via the one or more controls, the selector to encompass an area associated the object during the display of the content;
confirm, via the one or more controls, the area as a region of interest; and
transmit data indicative of the region of interest;
and,
the content player configured to:
receive the data indicative of the region of interest;
determine, based on the data indicative of the region of interest, a frame of the content and a timestamp associated with the frame;
extract coordinates from the frame, wherein the coordinates correspond to a position of the region of interest in the frame;
store the coordinates and the timestamp as information associated with the region of interest;
transmit an identifier associated with the content and the information associated with the region of interest; and
receive information associated with an object in the region of interest.

17. The system of claim 16, wherein the control device configured to cause the selector to encompass the area is further configured to adjust a position and size of the selector, wherein the position is determined from an origin associated with a coordinate system, and the size is associated with a length of the selector based on x-axis coordinates of the coordinate system and a height of the selector based on y-axis coordinates of the coordinate system.

18. The system of claim 16, wherein the information associated with the object comprises identification information, descriptive information, or a combination thereof.

19. The system of claim 16, wherein the information associated with the object comprises an advertisement associated with the object, a recommendation, or a combination thereof.

20. An apparatus comprising:
one or more processors; and
a memory having stored thereon processor executable instructions that, when executed by the one or more processors, cause the apparatus to:
receive an identifier associated with content and information associated with a region of interest associated with the content, wherein the information associated with the region of interest comprises coordinates and a timestamp;
determine, based on the identifier and the timestamp, a frame of the content;
determine, based on the coordinates, an object in the frame;
determine information associated with the object; and
transmit the information associated with the object.

21. The apparatus of claim 20, wherein the processor executable instructions that, when executed by the one or more processors, cause the apparatus to determine the object in the frame further comprise processor executable instructions that, when executed by the one or more processors, cause the apparatus to:
extract an image from the frame;
determine, based on the coordinates, a location of the object in the image;
crop the image to remove area of the image surrounding the location of the object; and
perform image processing on the cropped image.

22. The apparatus of claim 20, wherein the image processing comprises one or more of facial recognition, landmark detection, label detection, logo detection, optical character recognition, determining image attributes, or a combination thereof.

23. The apparatus of claim 20, wherein the processor executable instructions that, when executed by the one or more processors, cause the apparatus to determine the information associated with the object further comprise processor executable instructions that, when executed by the one or more processors, cause the apparatus to:
provide descriptive text associated with the object to a search engine; and
provide an image of the object to an image analyzer.

24. The apparatus of claim 20, wherein the information associated with the object comprises identification information, descriptive information, or a combination thereof.

25. The apparatus of claim 20, wherein the information associated with the object comprises an advertisement associated with the object, a recommendation, or a combination thereof.
